(19) United States
(12) Patent Application Publication
(10) Pub. No.: US 2018/0059887 A1
(43) Pub. Date: Mar. 1, 2018

(54) DIRECT NAVIGATION TO MODAL DIALOGS

(71) Applicant: Microsoft Technology Licensing, LLC, Redmond, WA (US)

(72) Inventors: Ryan A. Jansen, Kirkland, WA (US); Mark David Overholt, Bellevue, WA (US)

(21) Appl. No.: 15/245,025

(22) Filed: Aug. 23, 2016

(51) Int. Cl. G06F 3/0483; G06F 17/22; G06F 17/30

(52) U.S. Cl. CPC G06F 3/0483; G06F 3/04842; G06F 17/30887; G06F 17/2247

(57) ABSTRACT

Navigating directly to a modal dialog overlaying a base web page. User input associated with navigating to a modal dialog overlaying a base web page is detected. In response to detecting the user input, the computer system navigates directly to the modal dialog overlaying the base web page. The base web page acts as a background of the modal dialog, such that interaction with the model dialog is required prior to interaction with the base web page. Additionally, the modal dialog is associated with a first uniform resource locator, while the base web page is associated with a second, different uniform resource locator. As such, direct navigation can be performed either to the modal dialog or the base web page.

### BACKGROUND

Computer systems and related technology affect many aspects of society. Indeed, the computer system's ability to process information has transformed modern society. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks. Such networks allow for transferring electronic data to and from computer systems and other electronic devices.

Oftentimes the transfer of electronic data includes the sharing of data, applications, hyperlinks, photos, and so forth. For example, an individual may be able to almost instantaneously share a recently captured photo with family, friends, and co-workers. Recently, hyperlinks have been used to link, or deep-link, to content within applications and websites other than a homepage of those applications or websites. Deep-linking can allow end users to access desired content without the hassle of navigating through numerous pages of an application or website. For instance, an end user of a web application may receive a hyperlink associated with a particular page of the web application. By selecting the link, the user can navigate directly to the particular page without having to navigate first to the homepage or any other intermediate page.

### BRIEF SUMMARY

At least some embodiments described herein relate to navigating directly to a modal dialog overlaying a base web page. For example, embodiments may include detecting user input associated with navigating to a modal dialog overlaying a base web page. In response to detecting the user input, the computer system navigates directly to the modal dialog overlaying the base web page. The base web page acts as a background of the modal dialog, such that interaction with the model dialog is required prior to interaction with the base web page.

Accordingly, distinct uniform resource locators (URL) for each possible component of a web application or web page may allow for deep-linking directly to web pages within an application/website, modal dialogs overlaying base web pages, and tabs of modal dialogs. Deep-linking in this way may allow users of web applications and websites to navigate directly to a desired destination rather than navigating through homepages or any other intermediate page.

Furthermore, intelligent reloading of rendered components is enabled by a URL router that intercepts the ordinary logic of a web browser. Such intelligent reloading creates a smooth and uninterrupted user experience. Finally, individual HTML files associated with each possible component of a web application or web page may be pre-compiled into a single string file that is loaded into memory upon first launch of the web application/website. Once the string file is loaded into memory, the web browser can quickly and efficiently render specified content.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer system in which the principles described herein may operate.

FIG. 2 illustrates a web browser environment in which the principles described herein may operate.

FIG. 3 illustrates a flow chart of an example method for navigating directly to a modal dialog overlaying a base web page from a location other than the base web page.

FIG. 4 illustrates a flow chart of an example method for pre-compiling and loading into memory HTML files associated with each possible component to be rendered in a web application or web site.

FIG. 5 illustrates a flow chart of an example method for finding the correct file associated with a component to which a web browser is to navigate and render.

### DETAILED DESCRIPTION

At least some embodiments described herein relate to navigating directly to a modal dialog overlaying a base web page. For example, embodiments may include detecting user input associated with navigating to a modal dialog overlaying a base web page. In response to detecting the user input, the computer system navigates directly to the modal dialog overlaying the base web page. The base web page acts as a background of the modal dialog, such that interaction with the model dialog is required prior to interaction with the base web page.

Accordingly, distinct uniform resource locators (URL) for each possible component of a web application or web page may allow for deep-linking directly to web pages within an application/website, modal dialogs overlaying base web pages, and tabs of modal dialogs. Deep-linking in this way may allow users of web applications and websites to navigate directly to a desired destination rather than navigating through homepages or any other intermediate page.

Furthermore, intelligent reloading of rendered components is enabled by a URL router that intercepts the ordinary logic of a web browser. Such intelligent reloading creates a smooth and uninterrupted user experience. Finally, individual HTML files associated with each possible component of a web application or web page may be pre-compiled into a single string file that is loaded into memory upon first launch of the web application/website. Once the string file is loaded into memory, the web browser can quickly and efficiently render specified content.

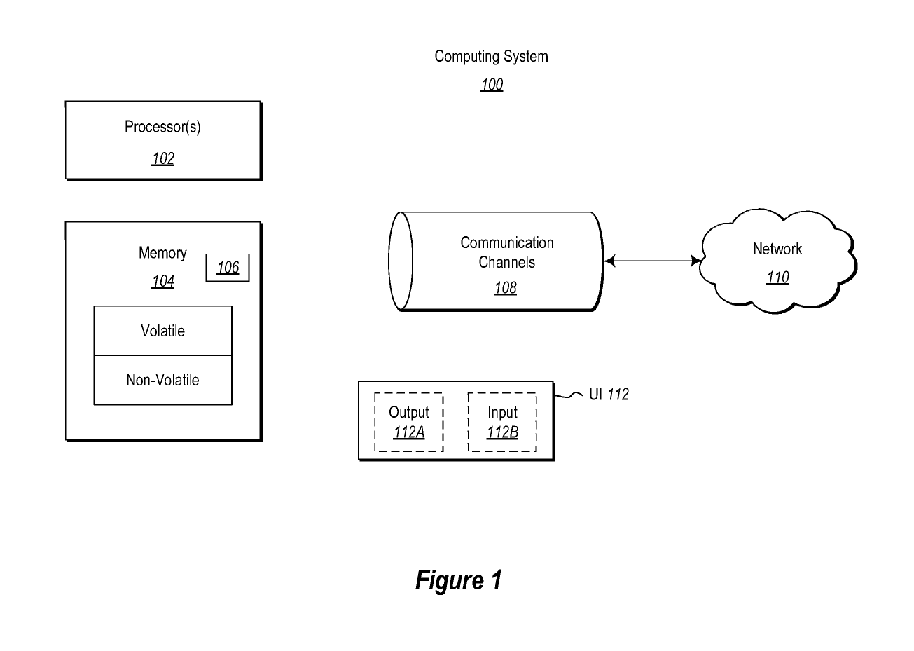

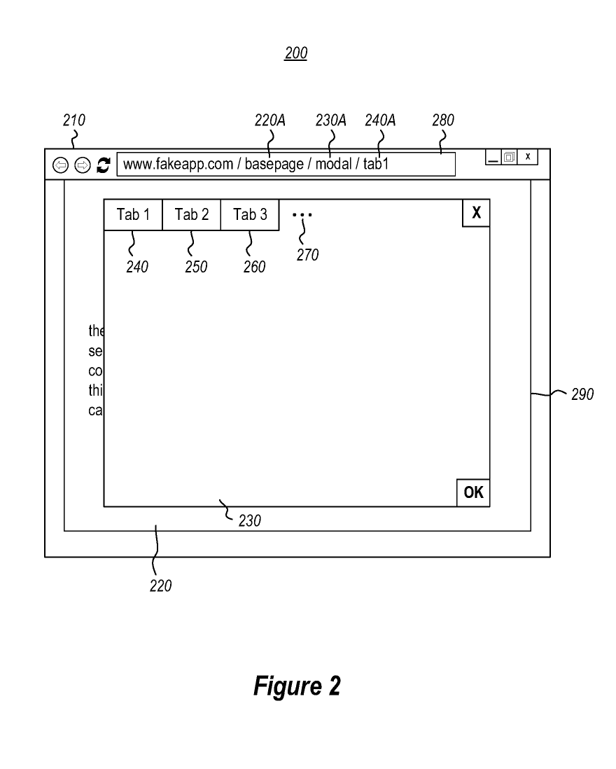

Some introductory discussion of a computing system will be described with respect to FIG. 1. Then, deep-linking to modal dialogs, reloading only changed components when navigating to a different URL, compiling all HTML files associated with possible components into a single string file, and loading the string file into memory will be described with respect to FIGS. 2 through 4.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, “interceptor” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIG. 2 illustrates a user interface environment 200 in which the principles described herein may operate. The user interface environment 200 may include, for instance, a user interface that is displayed on the display 112 of FIG. 1. The environment 200 includes a web browser 210 that may be any type of web browser. For instance, the web browser 210 may comprise web browsers such as MICROSOFT® INTERNET EXPLORER®, MICROSOFT EDGE, APPLE® SAFARI®, GOOGLE™ CHROME™, MOZILLA® FIREFOX®, and so forth, whether now existing or whether to be developed in the future. Additionally, web browser 210 may run on any type of operating system (OS). For example, the web browser may run on MICROSOFT WINDOWS®, APPLE OS X®, GOOGLE CHROME OS™, and so forth, whether now existing or whether to be developed in the future. In a more specific example, web browser 210 may be GOOGLE CHROME running on MICROSOFT WINDOWS.

As shown, web browser 210 includes navigation controls (e.g., back-page, forward-page, refresh, and so forth). The web browser 210 also includes an address/search bar 280 that allows for user input in the form of search terms, URL's, URI's, and so forth. Web browser 210 also includes rendering portion 290, in which content associated with websites, web pages, web applications, web services (and so forth) are rendered.

FIG. 2 also includes a base web page 220 that is being rendered on web browser 210. Base web page 220 may comprise a specific web page of a particular website or particular web application. As shown, a modal dialog 230 is overlaying base web page 220. Modal dialog 230 may suspend any user interaction with base web page 220 until the modal dialog 230 has been removed through user interaction with the modal dialog. Modal dialog 230 may include any information regarding base page 220, as described herein. Additionally, modal dialog 230 may have a plurality of tabs (i.e., Tab1 240, Tab2 250, and Tab3 260—collectively referred to herein as the tabs). While only three tabs are shown, ellipses 270 represent that there may be any number of tabs within modal dialog 230.

The principles described herein may be applied within the context of a particular domain (i.e., a website of a particular domain), as described more fully herein. Likewise, the principles described herein may be applied to a web version of an application. For example, base web page 220 may be a particular web page of a web version of MICROSOFT POWERAPPS™, while modal dialog 230 and the tabs may include content relating to a specific created application(s) within MICROSOFT POWERAPPS. In a more specific example, base web page 220 may be a web page that lists hyperlinks to all of the created applications of a user of a web version of MICROSOFT POWERAPPS. As such, modal dialog 230 may include content regarding a specific created application when a user has selected a hyperlink associated with the specific created application. In such an example, the modal dialog may have one or more tabs that each include content regarding a separate, specific created application. In other embodiments, each tab may include different content associated with the same specific created application. For example, a first tab may include content related to sharing the created application, while a second tab may include general information associated with the created application.

The base web page 220, the modal dialog 230, and each of the tabs may have a distinct URL that individually identifies the base web page, the modal dialog, and each of the tabs (while URL is used throughout the description, uniform resource identifier, or URI, may be equally applicable). Accordingly, a user may be able to navigate directly to any one of the base web page 210, the modal dialog, and/or any one of the tabs (i.e., each component may be deep-linkable). In other words, a web browser will be able to navigate directly to any one of the components described herein without having to first navigate to a homepage URL, or the like. For instance, suppose a user has received a hyperlink in an email or a text message associated with tab1 (as illustrated in FIG. 2). Furthermore, suppose that the hyperlink is the one shown in FIG. 2, www.fakeapp.com/basepage/modal/tab1 (note that this is a fake URL and only used as an example). When the user selects the link from any location (e.g., selecting the link in a dedicated email application, a dedicated text application, in a web browser, and so forth) the user will automatically be directed to tab1 240 of the modal dialog 230 that overlays base web page 220 (i.e., tab1 will be opened in a web browser).

Accordingly, a user may cause a web browser to navigate directly to a modal dialog overlaying a base web page, or any tab of such a modal dialog, in any number of ways. For example, a user may select a link associated with the distinct URL of a modal dialog or tab of a modal dialog that has been received (e.g., received by text, by email, by chat, and so forth). In another example, a user may interact with a navigation control of a web browser. In a more specific example, a user may enter the associated URL in an address bar of a web browser or select a navigation control to return to a previous component.

As illustrated in FIG. 2, specific portions of a given URL may be associated with the base web page, the modal dialog, and a specific tab. As shown, URL portion 220A may be associated with base web page 220, URL portion 230A may be associated with modal dialog 230, and URL portion 240A may be associated with Tab1 240. As discussed previously, this may allow a user to navigate directly to a modal dialog or a tab within a modal dialog (i.e., deep-linking). Additionally, this may allow the web browser to only refresh the components rendered within the web browser (i.e., the base web page, the modal dialog, any tabs, and so forth) that have actually changed.

More specifically, the web browser 210 may include a URL router that can identify specific portions of the URL that have changed, or not changed, when the overall URL changes. Generally, when such a change occurs, the web browser would attempt to navigate to the new URL, refreshing the entirety of what is being rendered by the web browser (e.g., a base web page, a modal dialog, and one or more tabs of the modal dialog). However, the URL router may intercept the web browser's logic that would ordinarily completely refresh all content that is being rendered by the web browser. The URL router may then inform the web browser of the specific URL portions that changed and therefore, are to be refreshed. In some embodiments, this URL router may only be capable of performing the functions described herein in relation to one or more particular web applications or websites having particular domain names. For example, the URL router may only perform these functions with respect to the domain name fakeapp.com.

In an example, assume that web browser 210 has navigated to the URL provided in FIG. 2 and is currently rendering Tab1 240 of modal dialog 230. When a user selects Tab2 250, the web browser may be directed to navigate to a new URL (e.g., www.fakeapp.com/basepage/modal/tab2). As such, the URL router may be able to determine that “www.fakeapp.com” has not changed, that “/basepage” has not changed, and that “/modal” has not changed, while “/tab1” has changed to “/tab2”. Accordingly, the URL router may inform the web browser that while the overall URL has changed, the only components rendered on the web browser to reload/refresh are the tabs (i.e., Tab1 and Tab2). Thus, the web browser may refrain from refreshing the base web page and the modal, while refreshing the newly selected tab (i.e., tab2). As such, despite the web browser responding to a different URL, the web browser may refrain from refreshing/reloading components that have not changed (i.e., the base page and the modal dialog in the previous example).

In another example, assume the web browser is currently rendering a base web page and a modal dialog (with or without tabs) overlaying the base web page. If a user closes the modal dialog, the URL will change to that of the base web page rather than the URL of the modal dialog. In response, the URL router may identify that the base web page portion of the URL has remained the same, while the modal dialog portion has changed. The URL router may then intercept the web browser logic that would ordinarily reload the base web page because of the URL change. A combination of the URL router and the web browser may then remove the overlaid modal while leaving the base page as is (i.e., the base page is not reloaded).

As such, the combination of the URL router and web browser would respond to the URL change (i.e., the user closing the modal dialog) in a manner that to an end user appears to simply be closing the modal dialog. Accordingly, regardless of which portions of a URL have changed, the URL router may be able to identify which URL portions have remained the same and which URL portions have changed each time the overall URL changes. In response, the URL router may communicate with the web browser in such a way as to cause the web browser to refrain from reloading the components associated with unchanged URL portions, while reloading/loading the components associated with changed or additional URL portions.

In some embodiments, the URL router may not only listen for URL changes, but may also load base web pages, launch modal dialogs, launch tabs of a modal dialog, and switch between tabs of a modal dialog overlaying the same base web page, as appropriate. Additionally, the URL router may launch a new modal dialog hosted on a current base web page, switch between tabs of a modal dialog overlaying a base web page without reloading/refreshing the base web page and modal dialog, launch a modal dialog hosted on a different base web page, and launch a specific selected tab of a modal dialog. In other embodiments, the previously described functions may all be performed by a web browser. In yet other embodiments, the previously described functions may be performed by a combination of the web browser and the URL router.

Furthermore, the principles described herein may also relate to single-page applications. Accordingly, the URL router and/or web browser may intercept logic of a single-page application that would function contrary to the principles describe herein. In other words, a combination of the URL router and web browser would still function in such a way that only changed URL portions reload, unchanged URL portions do not reload, and each web browser component (i.e., base web pages, modal dialogs, and tabs of modal dialogs) is deep-linkable.

In some embodiments, there may be animations when navigating to components (e.g., between two different tabs of a modal dialog) that help to mitigate or avoid the appearance of reloading a component. For example, assume that a user is attempting to navigate from one tab of a modal dialog to another tab of the same modal dialog. In such a case, rather than simply reloading the second tab, the second tab may be highlighted followed by a subsequent animation that presents the content included within the second tab. While such animations have been described with respect to switching between tabs, animations (or the like) may be used when first rendering or reloading any components.

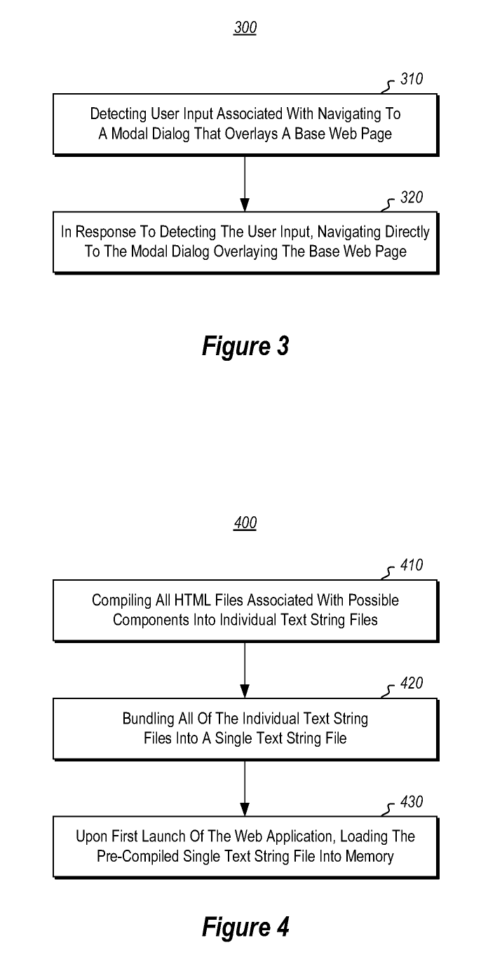

FIG. 3 illustrates a flow chart of an example method 300 for navigating directly to a modal dialog overlaying a base web page from a location other than the base web page. Method 300 will be described with respect to the components and data of computer architecture 100 and web browser environment 200. The method 300 includes detecting user input associated with navigating to a modal dialog that overlays a base web page (Act 310). For example, a user may input into the address bar of a web browser a URL that is associated with the modal dialog 230 that overlays the base web page 220.

In response to detecting the user input, the web browser navigates directly to the modal dialog overlaying the base web page (Act 320). For instance, the URL associated with the modal dialog may allow for deep-linking of the modal dialog, such that a user can navigate directly to the modal dialog rather than navigating to a base web page first. For example, the web browser may open in response to a user selecting a link received by the user in a text or email and then directly navigate to the modal dialog 230 overlaying base web page 220. In another example, the web browser may be on a first web page that is different from the base web page and receive input (e.g., entering the modal dialog URL in the web browser's address bar or selecting a hyperlink of the URL) to navigate directly to the modal dialog 230. In response, the web browser may navigate directly to the modal dialog overlaying the base web page.

Along with a distinct URL, each of the components rendered on web browser 210 (i.e., the base web page 220, the modal dialog 230, and the tabs) may also have a distinct hypertext markup language (HTML) file that includes the content to be rendered of the specific component. For instance, base web page 220 may have an associated page.html file, modal dialog 230 may have an associated modal.html file, Tab1 240 may have an associated tab1.html file, and so forth.

Generally, the default manner in which these HTML files are loaded into memory to be rendered includes loading a specific HTML file into memory only when a user has navigated to that particular component. In other words, each distinct view that a user can access (i.e., base web page, modal dialog overlaying a base web page, each tab of a modal dialog, and so forth) has a distinct, associated HTML file. For example, modal.html would only be loaded into memory when a user has navigated to the modal dialog 230. In such an instance, the web browser 210 would issue a hypertext transfer protocol (HTTP) request each time a user navigates to a different component (e.g., navigating from a base web page to a modal dialog). Accordingly, if a user navigated from Tab1 240 to Tab2 250, the web browser would issue an HTTP request for the tab2.html file and render Tab2 upon receiving the HTML file.

The default manner may also require multiple HTTP requests each time a user navigates to a deep-linkable component. For instance, suppose a user is navigating from outside of a base web page directly to a particular tab of a modal dialog overlaying the base web page (e.g., the user navigated there from a hyperlink in a text or email, or the user navigated there from a web page other than the base web page). Accordingly, when the user navigates to that deep-linkable tab, the browser will issue at least three HTTP requests, one for the base web page, one for the modal dialog, and one for the particular tab. As such, navigating between these components that each have both distinct URL's and distinct HTML files can create a substantial amount of HTTP requests that are detrimental to performance. Furthermore, at times, rendering content in response to HTTP requests may not be instantaneous resulting in a lag when rendering the requested HTML file (e.g., a blank screen may appear for a period of time after a user attempts to navigate to a specific component). Accordingly, a poor user experience may result.

As described previously, the principles described herein may be applied within the context of a web version of an application. For example, base web page 220 may be a particular web page of MICROSOFT POWERAPPS, while modal dialog 230 and the tabs may include content relating to a specific created application(s) within MICROSOFT POWERAPPS. Accordingly, to overcome these issues, all of the possible HTML files may be included in the source code of a web application. In other words, each possible base web page HTML file, each possible modal dialog HTML file, and each possible tab HTML file may be included in the web application's source code.

The collection of HTML files may then be converted/compiled into individual string files. For example, the individual string files may comprise JAVASCRIPT™ string files. Once converted into string files, all the strings may be compiled/bundled into a single file that is loaded during a start-up of the associated web application. For instance, all of the individual string files may be bundled into a single JAVASCRIPT string file that is loaded into memory. This effectively causes all of the HTML files to be loaded into memory during the initial loading of the web application, thus avoiding the problems caused by HTTP requests, as described herein. Accordingly, once loaded, the web application may be able to navigate to, and render, any possible component within the web application (i.e., base web pages, modal dialogs overlaying any base web page, and tabs of modal dialogs) by searching for the associated files in memory rather than performing an HTTP request to get HTML files for each component. Furthermore, because all of the component files are loaded in to memory upfront, loading/rendering any component is essentially instantaneous.

FIG. 4 illustrates a method for pre-compiling and loading into memory HTML files associated with each possible component to be rendered in a web application or web site. Method 400 includes compiling all HTML files associated with possible components into individual text string files (Act 410). For example, the HTML files associated with every possible component (base web pages, modal dialogs, and tabs of modal dialogs) may be compiled into JAVASCRIPT text string files. All of the individual text string files may then be bundled into a single text string file (Act 420). Continuing the previous example, all of the individual JAVASCRIPT text string files may be bundled into a single JAVASCRIPT text string file. Upon first launch of the web application (or website), the pre-compiled single text string file may then be loaded into memory (Act 430). For instance, suppose a user navigates to the web application. Upon launching the web application, a single JAVASCRIPT file that includes all of the individual HTML files of possible components will automatically be loaded into memory. As such, each time the user navigates to a different component to be rendered, the web browser can retrieve the component's associated file from memory, essentially instantaneously.

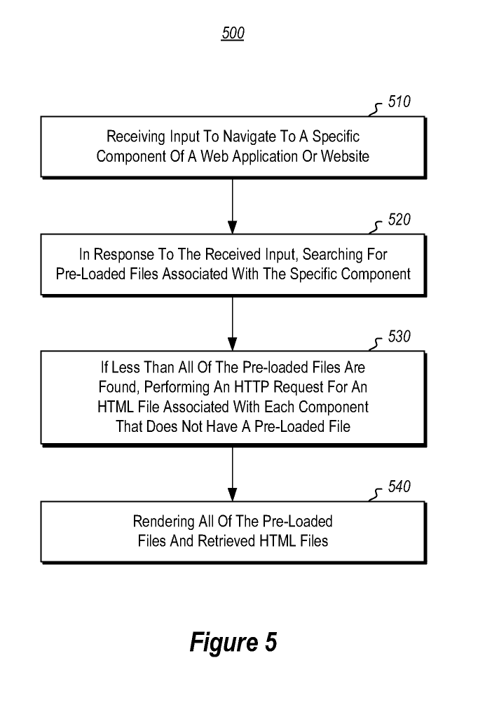

Furthermore, the web browser may be informed that all of these files have been loaded into memory such that web browser knows to check for the files in memory rather than issuing HTTP requests. Accordingly, FIG. 5 illustrates a method for finding the correct file associated with a component to which a web browser is to navigate and render. As shown, the web browser may receive input to navigate to a specific component of a web application or website (Act 510). For example, the web browser may receive input to navigate to tab1 240 of a modal dialog 230 overlaying a base web page 210.

In response to the received input, the web browser may search for pre-loaded files associated with the specific component (Act 520). In the ongoing example, the web browser may search for the JAVASCRIPT file that corresponds to the base web page, the modal dialog, and the tab to which the web browser is navigating. If less than all of the pre-loaded files are found, the web browser may then issue an HTTP request for an HTML file associated with each component that did not have a pre-loaded file (Act 530). For example, suppose the base web page and the modal dialog each had a pre-loaded file, but the tab did not. In response, the web browser would find the pre-loaded files for the base web page and the modal dialog in memory and perform an HTTP request for the HTML file associated with the tab. However, Act 530 should rarely, if ever occur, because in the context of a web application or website, all of the possible components to be rendered and associated URL's are known to the developers of the web application or website before any launch of the web application/website by an end user. Once the pre-loaded files and the HTML files have been retrieved, all of the retrieved files may be rendered within the web browser (Act 540).

Alternatively, the compiling of HTML files ultimately into a single string file may not include HTML files for every possible component. In some embodiments, a developer may manually determine which components are most likely to be used (and unused), and only compile the HTML files into individual string files (and ultimately a single file loaded into memory) that are deemed to be likely to be used. In other embodiments, HTML files may be compiled into string files based on a type of the associated component. In an example, HTML files associated with base web pages and modal dialogs may be compiled into JAVASCRIPT, while HTML files associated with tabs may not.

In yet other embodiments, some intelligence may be built into the web application or website, such that the use, and/or frequency of use, of components is tracked. Accordingly, based on past history of how components have been used, the web application or website may determine which HTML files to compile to string files. For example, perhaps only the most frequently used components will be compiled. In another example, all components that were recorded as being used at least once may have their associated HTML files compiled into string files. While a few examples have been provided, such intelligence could be implemented in any number of ways without departing from the spirit and essential characteristics of the principles described herein. Regardless of the implementation, with respect to the HTML files that are not pre-compiled into string files and later loaded into memory, the web browser may perform HTTP requests to retrieve those HTML files, just as the web browser would ordinarily do.

In this way, distinct URL's for each possible component of a web application or web page may allow for deep-linking directly to web pages within an application/website, modal dialogs overlaying base web pages, and tabs of modal dialogs. Deep-linking may allow users of web applications and websites to navigate directly to a desired destination rather than navigating through homepages or any other intermediate page.

Furthermore, intelligent reloading of rendered components is enabled by a URL router that intercepts the ordinary logic of a web browser. Such intelligent reloading creates a smooth and uninterrupted user experience. Finally, individual HTML files associated with each possible component of a web application or web page may be pre-compiled into a single string file that is loaded into memory upon first launch of the web application/website. Once the string file is loaded into memory, the web browser can quickly and efficiently render specified content.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system comprising:
one or more processors; and
one or more computer-readable storage media having stored thereon computer-executable instructions that are executable by the one or more processors to cause the computer system to allow for navigating directly to a modal dialog overlaying a base web page, the computer-executable instructions including instructions that are executable to cause the computer system to perform at least the following:
detect user input associated with navigating to a modal dialog overlaying a base web page; and
in response to detecting the user input, navigate directly to the modal dialog overlaying the base web page, the base web page being a background of the modal dialog, such that interaction with the model dialog is required prior to interaction with the base web page.

2. The computer system in accordance with claim 1, wherein the modal dialog is associated with a first uniform resource locator and the base web page is associated with a second, different uniform resource locator, such that the computer system allows for navigation directly either to the modal dialog overlaying the base web page or to the base web page.

3. The computer system in accordance with claim 1, wherein detecting the user input comprises detecting that a user has interacted with a prior web page that is different from the base web page, the interaction being in a manner that identifies the modal dialog overlaying the base web page.

4. The computer system in accordance with claim 3, the interaction comprising user interaction with a web navigation control.

5. The computer system in accordance with claim 3, the interaction comprising selection of a hyperlink associated with the modal dialog.

6. The computer system in accordance with claim 1, wherein the modal dialog includes one or more tabs, each tab having a distinct uniform resource locator.

7. The computer system in accordance with claim 6, wherein the base web page does not refresh when navigating from the modal dialog to a second modal dialog that overlays the base web page.

6. The computer system in accordance with claim 6, wherein the base web page, the modal dialog, and the one or more tabs each have a distinct hypertext markup language file.

9. The computer system in accordance with claim 8, wherein each distinct hypertext markup language file is compiled into a single JavaScript string file that is loaded into a memory of the computer system when navigating to the modal dialog overlaying the base web page.

10. A method, implemented at a computer system that includes one or more processors, for navigating directly to a modal dialog overlaying a base web page, comprising:
detecting user input associated with navigating to a modal dialog overlaying a base web page; and
in response to detecting the user input, navigating directly to the modal dialog overlaying the base web page, the base web page being a background of the modal dialog, such that interaction with the model dialog is required prior to interaction with the base web page.

11. The method in accordance with claim 10, wherein the modal dialog is associated with a first uniform resource locator and the base web page is associated with a second, different uniform resource locator, such that the computer system allows for navigation directly either to the modal dialog overlaying the base web page or to the base web page.

12. The method in accordance with claim 10, wherein detecting the user input comprises detecting that a user has interacted with a prior web page that is different from the base web page, the interaction being in a manner that identifies the modal dialog overlaying the base web page.

13. The method in accordance with claim 12, the interaction comprising user interaction with a web navigation control.

14. The method in accordance with claim 12, the interaction comprising selection of a hyperlink associated with the modal dialog.

15. The method in accordance with claim 10, wherein the modal dialog includes one or more tabs, each tab having a distinct uniform resource locator.

16. The method in accordance with claim 15, wherein the base web page does not refresh when navigating from a first tab to a second tab of the modal dialog.

17. The method in accordance with claim 15, wherein the base web page, the modal dialog, and the one or more tabs each have a distinct hypertext markup language file.

18. The method in accordance with claim 17, wherein each distinct hypertext markup language file is compiled into a single JavaScript string file that is loaded into a memory of the computer system when navigating to the modal dialog overlaying the base web page.

19. A computer program product comprising one or more hardware storage devices having stored thereon computer-executable instructions that are executable by one or more processors of a computer system to allow for navigating directly to a modal dialog overlaying a base web page, the computer-executable instructions including instructions that are executable to cause the computer system to perform at least the following in response to:
detecting user input associated with navigating to a modal dialog overlaying a base web page:
navigate directly to the modal dialog overlaying the base web page, the base web page being a background of the modal dialog, such that interaction with the model dialog is required prior to interaction with the base web page.

20. The computer program product in accordance with claim 19, wherein the modal dialog includes one or more tabs, each tab having a distinct uniform resource locator.
